(19) United States
(12) Patent Application Publication
(10) Pub. No.: US 2021/0205887 A1
(43) Pub. Date: Jul. 8, 2021

(54) THREE DIMENSIONAL (3D) PRINTED MOLDS HAVING BREAKAWAY FEATURES

(71) Applicant: Hewlett-Packard Development Company, L.P., Spring, TX (US)

(72) Inventors: Wei Huang, Palo Alto, CA (US); Gary J. Dispoto, Palo Alto, CA (US)

(73) Assignee: Hewlett-Packard Development Company, L.P., Spring, TX (US)

(21) Appl. No.: 17/054,594

(22) PCT Filed: Sep. 26, 2018
(86) PCT No.: PCT/US2018/052874

§ 371 Date: Nov. 11, 2020

(51) Int. Cl. B22F 10/14; B29C 64/165; B29C 33/38; B29C 33/44; B33Y 10/00; B33Y 80/00

(52) U.S. Cl. CPC B22F 10/14; B29C 64/165; B33Y 80/00; B29C 33/448; B33Y 10/00; B29C 33/3842

(57) ABSTRACT

Three dimensional (3D) printed molds having breakaway features are disclosed. An example method for forming a mold having a cavity by creating a plurality of layers using an additive manufacturing process includes providing a build material and varying a fusion level applied to the build material to form a first fused area and a second fused area on a layer of the mold, the second fused area is to define a breakaway feature of the mold.

### BACKGROUND

In three-dimensional (3D) printing, an additive printing process is often used to make three-dimensional solid parts from a digital model. 3D printing can be used in rapid product prototyping, mold generation, mold master generation, and short run manufacturing.

### BRIEF DESCRIPTION OF THE DRAWINGS

FIG. 1 is a block diagram an example workstation 100 that can be employed to manufacture a 3D printed mold in accordance with teachings of this disclosure.

FIG. 2 is a schematic illustration of an example process for forming the example 3D printed mold via the example workstation of FIG. 1.

FIG. 3 is a plan view of an example first layer of the example 3D printed mold of FIGS. 1 and 2.

FIG. 4 illustrates an example layer of the example 3D printed mold of FIGS. 1-3 formed with a varying porosity between an example first region and an example second region via an example contone-level control approach.

FIG. 5 illustrates another example layer of another example 3D printed mold having an example second region that includes a porosity that is different than the porosity of the example second region of the 3D printed mold of FIG. 4.

FIG. 6 illustrates an example layer of the example 3D printed mold of FIGS. 1-3 formed with a varying porosity between an example first region and an example second region via an example heat transfer control approach.

FIG. 7 illustrates another example layer of another example 3D printed mold having an example second region that includes a porosity that is different than the porosity of the example second region of the 3D printed mold of FIG. 6.

FIG. 8A is a top, perspective view of an example 3D printed mold that can implement the example 3D printed mold of FIGS. 1-7.

FIG. 8B is a partial, side view of the example 3D printed mold of FIG. 8A.

FIG. 9 is a top, perspective view of the example 3D printed mold of FIGS. 8A and 8B filled with an example moldable material to form an example molded part.

FIG. 10A is a top, perspective view and FIG. 10B is a side view of an example molded part formed by the example 3D printed mold of FIGS. 8A, 8B, and 9.

FIG. 11 illustrates the example 3D printed mold separated into a plurality of segments.

FIG. 12A is a top, perspective view of another example 3D printed mold that can implement the 3D printed mold of FIG. 1.

FIG. 12B is a cross-sectional view of the example 3D printed mold of FIG. 12A.

FIG. 13A is an example molded part formed via the example 3D printed mold of FIGS. 12A and 12B.

FIG. 13B is a cross-sectional view of the example molded part of FIG. 13A.

FIG. 14A illustrates an example digital model representative of the example 3D printed mold of FIGS. 8A and 8B.

FIG. 14B is a cross-sectional view of the example digital model of FIG. 14A.

FIG. 15A is an example digital model representative of the example 3D printed mold of FIGS. 12A and 12B.

FIG. 15B is a cross-sectional view of the example digital model of FIG. 15A.

FIGS. 16-18 are flowcharts illustrating example methods of forming 3D printed molds disclosed herein.

FIG. 19 is a block diagram of an example processing platform structured to execute instructions of FIGS. 16-18 to implement the example workstation of FIG. 1.

Where ever possible the same reference numbers are used throughout the drawing(s) and accompanying written description to refer to the same or like parts. The figures are not necessarily to scale and certain features and certain views of the figures can be shown exaggerated in scale or in schematic for clarity and/or conciseness. Additionally, several examples have been described throughout this specification. Any features from any example can be included with, a replacement for, or otherwise combined with other features from other examples.

### DETAILED DESCRIPTION

Certain examples are shown in the identified figures and disclosed in detail herein. Although the following discloses example methods and apparatus, it should be noted that such methods and apparatus are merely illustrative and should not be considered as limiting the scope of this disclosure.

As used herein, directional terms, such as “upper,” “lower,” “top,” “bottom,” “front,” “back,” “leading,” “trailing,” “left,” “right,” etc. are used with reference to the orientation of the figures being described. Because components of various examples disclosed herein can be positioned in a number of different orientations, the directional terminology is used for illustrative purposes and is not intended to be limiting.

Additive manufacturing processes can be used to manufacture parts having complex geometries. However, parts manufactured via additive printing processes are often limited to a small section of materials (e.g., 3D printable materials). For example, a small portion of polymer materials in the manufacturing industry can be used as 3D printing material(s). Thus, material availability has been a significant limitation for 3D printing processes compared to other manufacturing processes. Additionally, additive manufacturing processes can be expensive and/or can be time consuming process. In some instances, 3D printed parts can have relatively weak strength (e.g., mechanical strength, stress or strain characteristic(s)) compared to, for example, machined parts or molded parts. Other manufacturing processes employing molds are compatible with many different types of materials (e.g., thermoplastic and thermosetting polymer materials, etc.). However, such known manufacturing processes employing molds are limited to the production of simple geometries because complex parts cannot be separated from the molds.

Examples disclosed herein provide methods for manufacturing molds having complex geometries via additive manufacturing processes (e.g., 3D printed molds). For example, 3D printing techniques or processes are considered additive processes because the 3D printing processes involve the application of successive layers of material. Example 3D printing processes involve curing or fusing of a building material, which can be accomplished using heat-assisted extrusion, melting, or sintering, digital light projection technology, etc. For example, 3D printed objects can be printed using, for example, a multi-jet fusion (MJF) process. MJF is a powder-based technology. A powder bed is heated uniformly at the outset. A fusing agent is jetted where particles need to be selectively molten, and a detailing agent is jetted around the contours to improve part resolution. While lamps pass over a surface of the powder bed, the jetted material captures the heat and helps distribute the heat evenly.

In some examples disclosed herein, 3D printed molds can be manufactured via MJF technology. The 3D printed molds are then employed in other manufacturing processes such as, for example, injection molding, casting etc., to manufacture parts using non-3D printable materials. After formation of the 3D printed mold, a moldable material can be provided in a cavity of the 3D printed mold. As used herein, a “moldable material” is any material such as, for example, a liquid, a powder, clay, etc., that becomes liquid or malleable when heated (e.g., to a temperature of 150 degrees Fahrenheit (° F.)) and solidifies when cooled (e.g., to room temperature). For example, the moldable material can be, for example, a liquid or a powder, a polymer, a molten material, a liquid polymer, a polymer mixed with metal or ceramics, a low-temperature metal, and/or any other suitable material(s). The moldable material can then be treated (e.g., cooled, cured, etc.) for solidification. After solidification of the molded material, the mold can be separated (e.g., destroyed and removed) from the molded part. Thus, the example 3D printed molds disclosed herein can be single use molds that can be broken down and removed from a molded part after formation of the molded part.

In 3D printing processes, full solidification of materials has always been desired for highest mechanical strength possible. For example, in thermal powder bed-based 3D printing processes, such as MJF for plastic materials, process parameters are optimized to avoid under-fused powder to form fully dense parts (e.g., 0% to 1% porosity). As used herein, “porosity” means a measure of a void (i.e. “empty”) spaces in a material. In some examples, porosity is determined as a fraction of a volume of voids over a total volume, or as a ratio of a volume of interstices of a material to a volume of its mass. A degree of fusion in powder bed-based 3D printing processes affects resulting material properties such as, for example, Young's modulus, ultimate strain and stress, etc. Therefore, printing a 3D part with an under-fused polymer powder can present mechanical strength properties different from mechanical strength properties of a fully-fused polymer powder.

To enable separation of the mold from the molded part, example molds disclosed herein can be formed with weakened area or breakaway features (e.g., under-fused polymer powder) during the 3D printing process. To form the breakaway features, a level of fusion of a part is varied during 3D printing process. As used herein, a level of fusion refers to controlling an amount of heat to be received by a build material to affect or control an amount of melt of particles to be selectively molten and, thus, vary a porosity of a part (e.g., a 3D printed mold). For example, to form the breakaway features and/or vary a level of fusion, a level of a fusing agent or binding or bonding agent for 3D binder jetting is varied during the printing process, an amount of heat applied to different regions of the 3D part is varied to vary (e.g., increase or decrease) a level of molten of particles of the different regions, a cooling agent may be provided to control (e.g., lower) a temperature of a first region relative to a second region to reduce the number of particles that become molten. For example, forming 3D printed molds disclosed herein with under-fused powder decreases a mechanical strength of the under-fused area compared to a mechanical strength of a fully-fused powder.

In other words, controlling a fusion level can alter mechanical strength characteristics of the molded part. For example, first portions of the 3D printed mold can have a first strength characteristic and second portions of the 3D printed mold can have a second strength characteristic different than (e.g., less than) the first strength characteristic. Therefore, different portions of the mold can be weakly connected to enable removal of the 3D printed mold from a molded part. As a result, the 3D printed mold has sufficient strength to maintain its shape during a molding process but can be broken down after formation of the molded part.

To control fusion levels or characteristics, the examples disclosed herein control a temperature of a first portion or region (e.g., of a layer) of a 3D printed part relative to a temperature of a second portion or region (e.g., of a layer) of the 3D printed part. To vary the porosity and/or a level a fusion, the examples disclosed herein vary a fusing agent (e.g., MJF process), a detailing agent (e.g., a cooling agent), an energy level (e.g. SLS process), a binder agent (e.g., 3D binder jetting), etc.

For example, to control fusion levels or characteristics and/or vary a porosity during an MJF 3D printing process, example disclosed herein employ (1) a contone level-controlled approach or (2) a heat transfer-controlled approach. In the contone level-controlled approach, fusing agents are applied to the under-fused regions at lower contone levels than that of the fully fused regions. The desired fusing degree of the under-fused region can be achieved by the corresponding contone level. In the heat-transfer-controlled approach, no fusing agent is applied to the under-fused region. Instead, a region is solidified by the heat (e.g., thermal bleed) from the fully fused regions adjacent the under-fused region. Different portions of the mold can therefore be weakly connected.

To vary porosity and/or fusing level characteristics during a selective laser sintering (SLS) process, examples disclosed vary an energy provided to a build material during the SLS process. For example, an SLS process employs a laser that provides energy sufficient to cause particles of a build material to fuse together and form a solid structure. Thus, to vary the porosity, a first energy level (e.g., a first amount of heat) can be provided to the first region (e.g., of a first layer) of a 3D printed mold and a second energy level (e.g., a second amount of heat) can be provided to the second region (e.g., the first layer) of the 3D printed mold. In some examples, the first energy level is provided by a first laser and the second energy level is provided by a second laser.

Example disclosed herein can be employed with 3D binder jetting processes. For example, 3D binder jetting is an additive manufacturing process that forms 3D printed parts or molds additively with a binding agent. In some examples, the 3D binder jetting process uses a liquid binding agent deposited on a metal powder material, layer by layer, according to a 3D model. In some such examples, a porosity of (e.g., a first layer) of a 3D printed mold can be varied by varying at least one of the binder agent or an energy applied to a build material and the binder agent.

In some examples, the example methods disclosed herein can employ a detailing agent (e.g., a cooling agent) to vary a porosity of a 3D printed mold. The detailing agent maintains a temperature of a second portion of a build material cooler than a temperature of a first portion of a build material during a printing process to reduce or prevent the effects of thermal bleed between the first portion and the second portion and, thereby, vary a porosity between the first and second portions. Thus, although the example disclosed herein are discussed in connection with MJF process, the examples can be implemented with SLS processes, 3D binder jetting processes, and/or any other additive manufacturing process(es).

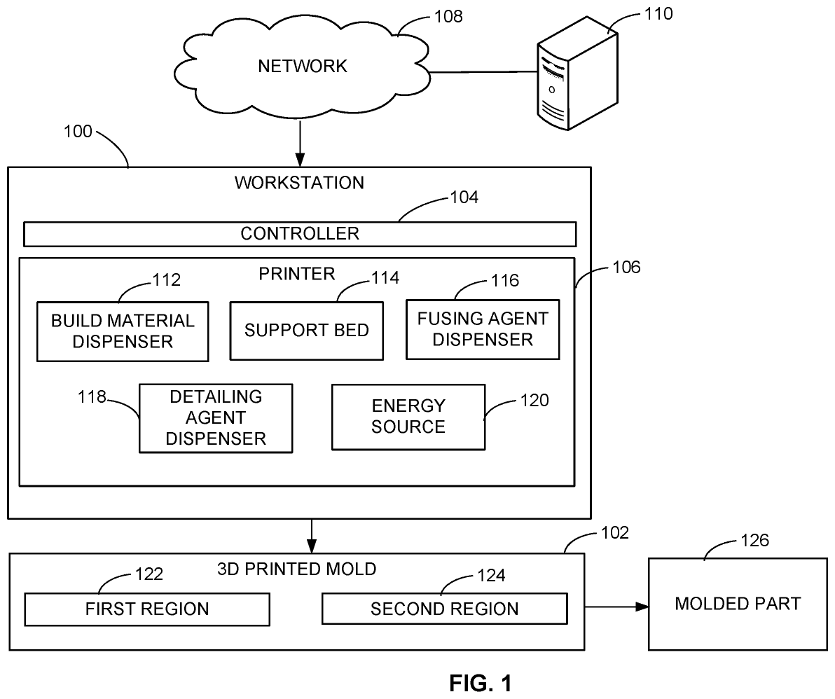

Further, the variation of porosity between a first region and a second region (e.g., of a layer) of a 3D molded part disclosed herein defines a breakaway feature. Thus, the example 3D printed molds disclosed herein do not include any inserts or structures (e.g., metal inserts) to define or enable the breakaway feature. The breakaway features are enabled by a variation of the porosity or fusion level of the first region and the second that is controlled during manufacturing or printing (e.g., an MJF printing process, an SLS printing process, a 3D binder jetting process, etc.) of the 3D printed mold 102. Turning more specifically to the illustrated examples, FIG. 1 depicts an example workstation 100 that can be employed to manufacture a 3D printed mold 102 in accordance with teachings of this disclosure. The workstation 100 of the illustrated example employs MJF technology to fabricate the 3D printed mold 102. The 3D printed mold 102 may be formed through an MJF process where powder particles are fused together through application of a fusing agent and heat. In some examples, the workstation 100 can be a Jet Fusion 4200 series 3D printer manufactured by HP, Inc. The 3D printed mold 102 can be composed of material(s) including, for example, polymers or a mixture of polymer and metal/ceramic material(s) including, but not limited to, nylons (e.g., nylon 12, nylon 11, nylon 6, etc.), polypropylenes, polyethylene, thermoplastic polyurethane and/or any other semi-crystalline thermoplastic(s) and/or polymer material(s).

The workstation 100 includes an example controller 104 and an example printer 106 (e.g., a 3D printer). The controller 104 may be a computing device, a semiconductor-based microprocessor, a central processing unit (CPU), an application specific integrated circuit (ASIC), and/or other hardware processing device. The controller 104 can be communicatively coupled to an example computing device 110 (e.g., a desktop, a server, etc.) via an example network 108 (e.g., a wireless network, a wired network, etc.). For example, the computing device 110 may be a computer that sends instructions to the controller 104 to print or produce the 3D printed mold 102. While an example network topology is shown in FIG. 1, any appropriate network topology may be implemented.

The printer 106 of the illustrated example includes an example build material dispenser 112, an example support bed 114, an example fusing agent dispenser 116, an example detailing agent dispenser 118, and an example energy source 120. The build material dispenser 112, the fusing agent dispenser 116, and/or the detailing agent dispenser 118 can be inkjet cartridge(s) or print heads that eject material(s) during a printing process. The energy source 120 can be, for example, infrared light, ultraviolet light, a heat lamp, a heating element, and/or can be any other source that produces heat.

The printer 106 of the illustrated example produces the 3D printed mold 102 with an example first area or first region 122 and an example second area or second region 124 different than the first region 122. The 3D printed mold includes a plurality of layers. Thus, the first region of a first layer of the 3D printed mold 102 aligns with a first region (e.g., a third region) of the second layer and the second region of the first layer aligns with a second region (e.g., a fourth region) of the second layer. In the examples disclosed herein, one layer or multiple layers can define the first region 122 and/or the second region 124.

The first region 122 of the illustrated example is formed with a first porosity, and the second region 124 is formed with a second porosity different than the first region 122. In particular, the first porosity may be less than the second porosity. In some examples, the first porosity is between approximately 0% and 5%. In some examples, the second porosity is between approximately 10% and 90% greater than the first porosity. In some examples, the second porosity can between approximately 30% and 80% greater than the first porosity. Thus, the first region 122 has a greater density than the second region 124.

As a result of the varying porosities, the first region 122 has a first mechanical strength characteristic (e.g., ultimate strain and stress, impact resistance, etc.) that is different than (e.g., greater than) a second mechanical strength characteristic (e.g., ultimate strain and stress, Impact resistance) of the second region 124. For example, when the 3D printed mold 102 is composed of nylon 12, the first region 122 (e.g., a fully-fused region) can have an ultimate stress characteristic of between approximately 25 megapascal (MPa) and 80 megapascal (MPa) (e.g., 60 MPa), and the second region 124 (e.g., a partially-fused region) can have an ultimate stress characteristic of between approximately 5 megapascal (MPa) and 20 megapascal (MPa) (e.g., 10 MPa). In some examples, when the 3D printed mold 102 is composed of notched nylon 12, the first region 122 can have an Izod Impact characteristic of between approximately 2 KJ/m² and 10 KJ/m² (e.g., 3.5 KJ/m²), and the second region 124 (e.g., a partially-fused region) can have an Izod Impact characteristic of between approximately 0.1 KJ/m² and 3 KJ/m² (e.g., 1 KJ/m²). To this end, the second region 124 provides a breakaway feature that enables or facilities separation of the first region 122 into multiple segments or structures. Thus, a force imparted to the second region 124 can cause the second region 124 to break, while the first region 122 can withstand the same amount of force. To provide the breakaway feature, the controller 104 of the illustrated example causes the printer 106 to vary a porosity of a 3D molded part during the printing operation to provide at least the first region 122 having a first porosity and the second region 124 having a second porosity that is greater than the first porosity. To achieve varying porosity between the first region and the second region, the examples disclosed herein control a temperature or heat absorption of a build material during printing of the first and second regions. To control the temperature of a build material of the first and second regions during printing process and vary the porosity of the 3D printed mold 102, examples disclosed herein include controlling at least one of: (1) a contone level of a fusing agent; or (2) a heat transfer during the printing process. The varying degree of porosity between the first region 122 and the second region 124 is controlled by a level of fusion between the first region 122 and the second region 124. For example, the first region 120 has a fully-fused area (e.g., a small porosity of, for example, between 0% and 5%), and the second region 124 has a partially or under-fused area (e.g., a large porosity of, for example, between 10% and 90%). This level of fusion variation is controlled by controlling a temperature of the first region 122 relative to the second region 124. In other words, the fusing agent can be employed to control a temperature of the second region 124 relative to the first region 122.

After formation of the 3D printed mold 102, the 3D printed mold 102 can be used to form a molded part 126 via other molding (e.g., casting) manufacturing processes. After the molded part 126 solidifies in the 3D printed mold 102, the 3D printed mold 102 is removed from the molded part 126 by separating the 3D printed mold 102 into multiple segments or pieces via the second region 124. The segments of the 3D printed mold 102 are removed from the molded part 126.

The examples disclosed herein are not limited to MJF process. For example, the workstation 100 can be configured to implement any other suitable additive manufacturing processes. In some examples, the examples disclosed herein can employ a detailing agent process, a selective laser sintering (SLS), or a 3D binder jetting process to vary a porosity between the first region 122 and the second region 124 of the 3D printed mold 102.

To implement a detailing agent process, the workstation 100 of FIG. 1 can be configured to dispense a detailing agent (e.g., water, a cooling agent, etc.) to control a temperature of the first region 122 and the second region 124. For example, the controller 104 can cause a detailing agent dispenser to dispense a detailing agent (e.g., a liquid, water, etc.) on a build material corresponding to the second region 124. Such application of the detailing agent can occur without use of a fusing agent on the build material associated with the second region 124. In some examples, a combination of the fusing agent and the detailing agent can be used on the second region 124 to increase a porosity of the second region 124. During a fusing process (e.g., of a layer) of the 3D printed mold 102 that occurs during a printing process, the fusing agent disposed on the build material associated with the first region 122 absorbs a greater amount of heat than a portion of the build material that includes the detailing agent associated with the second region 124. In this manner, the first region 122 heats to a temperature that is greater than the second region 124 to cause the first region 122 to become molten and fuse together with a less porosity than the second region 124. Additionally, the detailing agent provided on the build material corresponding to the second region 124 maintains a temperature of the build material cooler than a temperature of the build material corresponding to the first region 122 to reduce or prevent the effects of thermal bleed from the heat of the first region 122 to the second region 124 due to the temperature of the first region 122. In other words, the detailing agent can be employed to control a temperature of the second region 124 relative to the first region 122.

Alternatively, in some examples, the workstation 100 can be configured to implement a selective laser sintering (SLS) apparatus or process. In some such examples, the energy source 120 can be a laser that applies energy to a build material provided by the build material dispenser 112. To vary a porosity of a 3D printed mold between a first region (e.g., of a first layer of the 3D printed mold) and a second region (e.g., of the first layer of the 3D printed mold), the energy source 120 varies an amount of energy provided to (e.g., a layer of) the 3D printed mold. For example, the controller 104 can command the energy source 120 to provide a first amount of energy to the first region of the 3D printed mold and a second amount of energy different than the first to a second region of the 3D printed mold. The varying amount of energy causes particles of a build material to fuse with different porosities. For example, the first region can be formed with a first porosity (e.g., 0 to 5%) and the second region can be formed with a second porosity (e.g., 10% to 90%) different than the first porosity. In some such examples, the workstation 100 does not include the fusing agent dispenser 116 and the detailing agent dispenser 118.

In some examples, the workstation 100 can be configured to implement a 3D binder jetting process. For example, the printer 106 can include a binder agent dispenser instead of the fusing agent dispenser 116 and the detailing agent dispenser 118. To vary a porosity of a 3D printed mold, the printer 106 can vary at least one of a binder agent provided to a build material or an amount of energy provided to the binder agent and the build material. For example, to vary the porosity between first and second regions, the controller 104 can cause the binder dispenser to dispense a first amount of binder agent on a first region (e.g., of a first layer) of the 3D printed mold and a second amount of binder agent on a second region (e.g., of the first layer) of the 3D printed mold. In some examples, to vary the porosity, the controller 104 causes the energy source 120 to provide a first amount of energy or first energy level to a first region (e.g., of a first layer) of the 3D printed mold and a second amount of energy or second energy level to a second region (e.g., a second layer) of the 3D printed mold. In some examples, a porosity between a first region and a second region of the 3D printed mold can be varied by varying the binder agent and the energy applied to the binder agent and a build material.

Further, the example breakaway feature is defined based on the varying porosity between the first and second regions 122, 124. Thus, the example 3D printed mold 102 does not include any inserts or structures (e.g., metal inserts) to define or enable the breakaway feature. The breakaway feature is enabled by a variation of the porosity or fusion level of the first region 122 and the second 124 that is controlled during printing (e.g., an MJF printing process, an SLS printing process, a 3D binder jetting process, etc.) of the 3D printed mold 102.

While an example manner of implementing the workstation 100 is illustrated in FIG. 1, any or some the elements, processes, and/or devices illustrated in FIG. 1 may be combined, divided, re-arranged, omitted, eliminated, and/or implemented in any other way. Further, the example controller 104, the example printer 106, the example build material dispenser 112, the example support bed 114, the example fusing agent dispenser 116, the example detailing agent dispenser 118, the example energy source 120 and/or, more generally, the example workstation 100 of FIG. 1 may be implemented by hardware or machine readable instructions including, for example, software or firmware, and/or implemented by any combination of hardware, software and/or firmware. Thus, for example, any of the example controller 104, the example printer 106, the example build material dispenser 112, the example support bed 114, the example fusing agent dispenser 116, the example detailing agent dispenser 118, the example energy source 120 and/or, more generally, the example workstation 100 of FIG. 1 could be implemented by analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)). When reading any of the apparatus or system claims of this patent to cover an implementation of purely machine readable instructions, at least one of the example controller 104, the example printer 106, the example build material dispenser 112, the example support bed 114, the example fusing agent dispenser 116, the example detailing agent dispenser 118, the example energy source 120, and/or, more generally, the example workstation 100 of FIG. 1 is/are hereby expressly defined to include a non-transitory computer readable storage device or storage disk such as a memory, a digital versatile disk (DVD), a compact disk (CD), a Blu-ray disk, etc. including the software and/or firmware (e.g., machine readable instructions). Further still, the example workstation 100 of FIG. 1 may include other element(s), process(es), and/or device(s) in addition to, or instead of, those illustrated in FIG. 1, and/or may include more than one of any or all of the illustrated elements, processes, and devices. As used herein, the phrase “in communication,” including variations thereof, encompasses direct communication and/or indirect communication through intermediary component(s), and does not require direct physical (e.g., wired) communication and/or constant communication, but rather additionally includes selective communication at periodic intervals, scheduled intervals, aperiodic intervals, and/or one-time events.

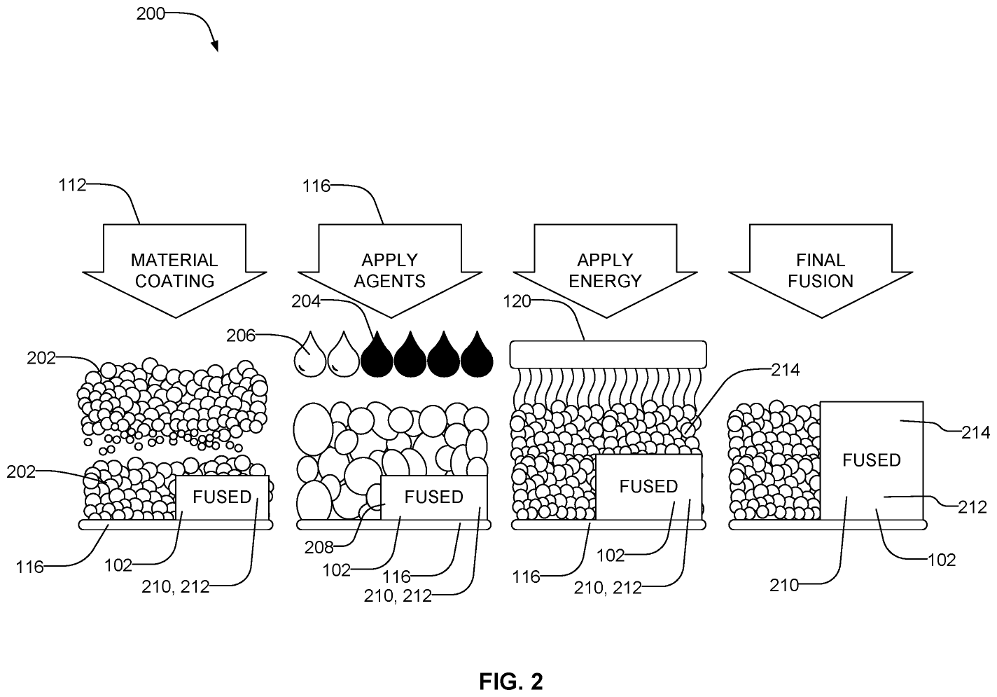

FIG. 2 is a schematic illustration of an example additive manufacturing process 200 (e.g., an MJF process) for forming the 3D printed mold 102 via the workstation 100 of FIG. 1. To form the 3D printed mold 102, the controller 104 receives instructions (e.g., via the computing device 110 and/or the network 108) to fabricate the 3D printed mold 102. For example, the controller 104 can receive instructions representative of a desired pattern to create or generate the 3D printed mold 102. The controller 104 of the illustrated example causes the build material dispenser 112, the fusing agent dispenser 116, the detailing agent dispenser 118, and the energy source 120 to move along a pre-determined pattern relative to the support bed 114 to generate or build the 3D printed mold 102. For example, the instructions may be provided via a digital file formed using computer aided design (CAD) programming.

To produce the 3D printed mold 102, the controller 104 causes the build material dispenser 112 to dispense a build material 202 on the support bed 114 (e.g., a powder bed-based 3D printing processes). The build material 202 is a powder based material (e.g., nylon powder). In some examples, the build material dispenser 112 dispenses or deposits the build material uniformly across (e.g., an entire) working area of the support bed 114. To facilitate fusion (e.g., solidification) of the build material 202, the fusing agent dispenser 116 dispenses a fusing agent 204 (e.g., an agent) on the build material 202. Specifically, the fusing agent 204 is jetted on the build material 202 at specific locations or regions where particles of the build material 202 are to be selectively molten or fused together. To generate a pattern corresponding to the 3D printed mold 102, the controller 104 of the illustrated example controls dispensing the fusing agent 204 at specific locations relative to the build material 202 via the fusing agent dispenser 116. In some examples, a detailing agent 206 is jetted (e.g., via the detailing agent dispenser 118) around the contours of fused portions of the 3D printed mold 102 to improve part resolution. Typically, the detailing agent 206 is provided at peripheral or terminating edge 208 of the 3D printed mold 102. In contrast to the fusing agent 204, the detailing agent 206 reduces or prevents fusion or solidification of the build material 202.

To solidify or fuse the build material 202 to a structural component 210 (e.g., a solid structure), the controller 104 causes the energy source 120 (e.g., infrared light) to heat (e.g., pass over) the build material 202. As the energy source provides heat to the build material 202, the fusing agent 204 absorbs the heat and distributes the heat evenly to portions of the build material 202 that includes the fusing agent 204. Thus, the fusing agent 204 enhances fusion or solidification of the build material 202. The detailing agent 206, on the contrary, reflects heat from the energy source 120 and does not allow the build material 202 to solidify or fuse, thereby facilitating removal of the 3D printed mold 102 from the support bed 114.

After a first layer 212 of the 3D printed mold 102 is formed, a second layer 214 of the 3D printed mold 102 is formed. For example, after formation of the first layer 212, the controller 104 causes the build material dispenser 112 to deposit the build material 202 on the first layer 212 and causes the fusing agent dispenser 116 to dispense the fusing agent 204 on select regions of the build material 202 of the second layer 214 that is to molten or solidify. The energy source 120 applies energy to the build material 202, and the build material 202 solidifies at locations that includes the fusing agent 204 to form the second layer 214 of the 3D printed mold 102. The process repeats to form a plurality of layers until formation of the 3D printed mold 102 is completed.

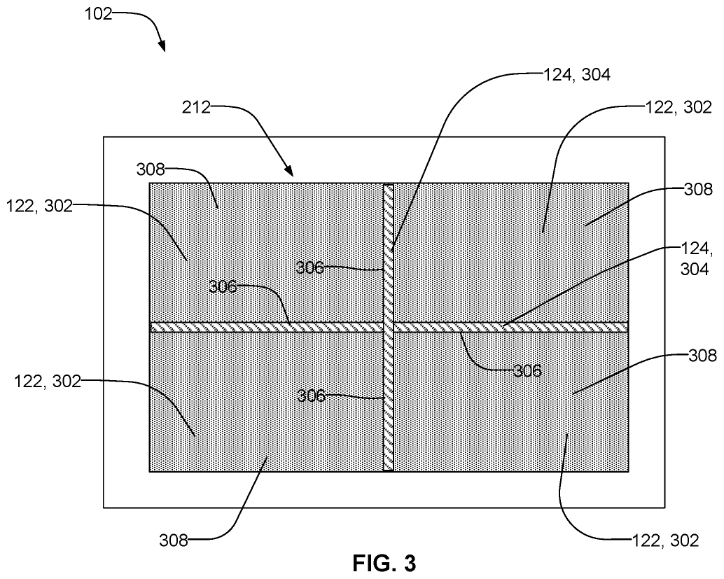

FIG. 3 is a plan view of the first layer 212 of the 3D printed mold 102 of FIGS. 1 and 2. The first layer 212 of the 3D printed mold 102 of the illustrated example includes the first region 122 and the second region 124. Specifically, the first region 122 of the illustrated example includes a plurality of first regions 302 and the second region 124 of the illustrated example includes a plurality of second regions 304. The first regions 302 of the illustrated example are produced with the first porosity and the second regions 304 are produced with the second porosity different than the first porosity. Additionally, the controller 104 causes the second region 124 of the first layer 212 to align with a second region of the second layer 214 during the printing operation of the 3D printed mold 102. The second regions 304 of the illustrated example enable separation of the first regions 302 into multiple segments (e.g., four segments). To this end, the second regions 304 define breakaway features 306 that enable the first regions 302 to separate (e.g., break off) into multiple segments or structures 308.

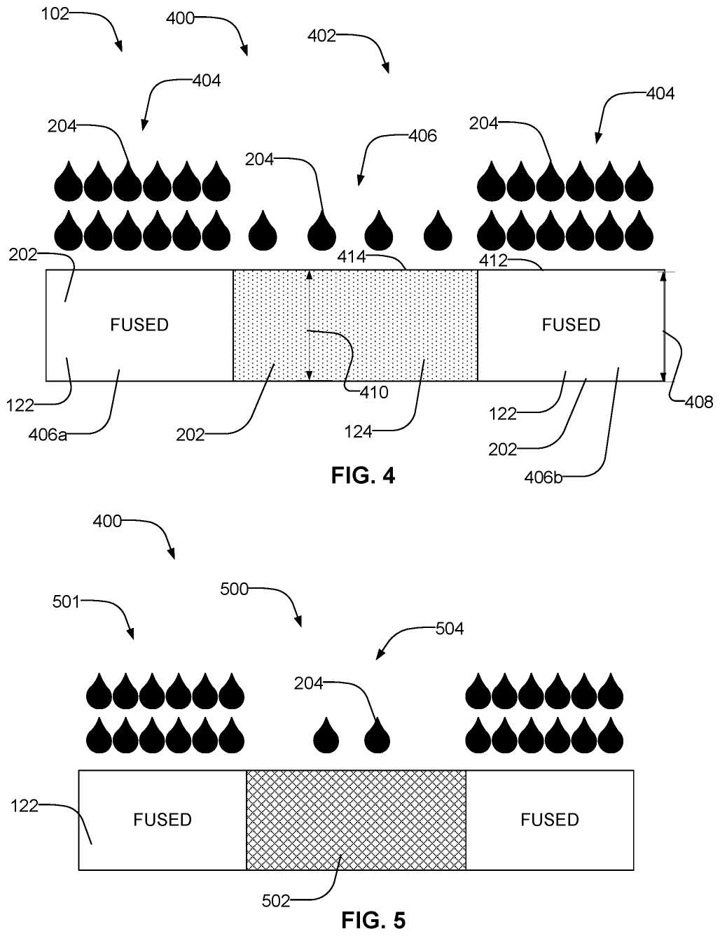

FIG. 4 is schematic illustration of an example layer 402 (e.g., the first layer 212 of FIG. 2) of the 3D printed mold 102 formed with a varying porosity between the first region 122 and the second region 124 via an example contone-level control approach 400. To vary a porosity between the first region 122 and the second region 124 of the 3D printed mold 102, the controller 104 controls a contone level of the fusing agent 204 deposited or dispensed (e.g., jetted) on the build material 202 via the fusing agent dispenser 116. For example, the first region 122 receives a first amount 404 of the fusing agent 204 and the second region 124 receives a second amount 406 the fusing agent 204. Specifically, in this example, the first amount 404 is greater than the second amount 406. In some examples, the first amount 404 can be between 10% and 90% greater than the second amount 406. The varying first and second amounts 404, 406 of fusing agent 204 between the first and second regions 122, 124 effects a degree of fusion of the build material 202 (e.g., a powder) when heat is applied to the build material 202 via the energy source 120. For example, the first amount 404 of fusing agent provided on the first region 122 causes the first region 122 to fuse completely (e.g., a fully-fused region) when energy is provided by the energy source 120. In contrast, the second amount 406 of fusing agent 204 provided on the second region 124 causes the second region 124 to partially fuse (e.g., under-fused region). The first amount 404 of fusing agent 204 absorbs more energy or heat from the energy source 120 than the second amount 406 of fusing agent 204. In effect, the first region 122 is elevated to a temperature that is greater than a temperature of the second region 124 during printing. As a result, a greater amount of the build material 202 in the first region 122 becomes molten and solidifies together compared to an amount of build material 202 in the second region that becomes molten and solidifies (e.g., due to the temperature difference). As a result, the first region 122 solidifies with the first porosity that is less than the second porosity of the second region 124. The varying porosity between the first region 122 and the second region 124 affects the resulting material properties of the first and second regions 122, 124 including, but not limited to, for example, Young's modulus, ultimate strain and stress, etc. Because the second porosity is greater than the first porosity, the second region 124 has a weaker mechanical strength than a mechanical strength of the first region 122. For example, the first region 122 can withstand an impact force of 100 Newtons (N) without breaking or becoming damaged, but the second region 124 cannot withstand such impact force. Thus, imparting a force to the second region 124 causes a first portion 406a of the first region 122 to separate or detach from a second portion 406b of the first region 122 along the second region 124.

The difference of porosity between the second region 124 (e.g., the under-fused region) and the first region 122 (e.g., a fully-fused region or a relatively greater fused region) does not affect a thickness (e.g., a wall thickness) of the 3D printed mold 102. For example, a first thickness 408 of the first region 122 is substantially similar (e.g., within 1%) or identical relative to a second thickness 410 of the second region 124. For example, an outer surface 412 (e.g., an upper surface) of the first region 122 is substantially flush (e.g., even) relative to an adjacent outer surface (e.g., an upper surface) of the second region 124. Thus, the second region 124 does not provide a stepped or recessed portion (but rather, e.g., provides a smooth transition) between the second region 124 and the first region 122.

FIG. 5 illustrates another example layer 500 of another example 3D printed mold 501 having a second region 502 that includes a porosity that is different than the porosity of the second region 124 of FIG. 4. Specifically, a degree or amount of porosity of the second regions 124, 502 can be varied (e.g., increased or decreased) by controlling an amount of the fusing agent 204 provided on the build material 202 during printing. Thus, different porosities of the second regions 124, 502 can be achieved by varying an amount of the fusing agent 204. Referring to FIG. 4, for example, the second amount 406 of the fusing agent 204 is employed to form the second region 124 with a 20% porosity. As shown in FIG. 5, a second amount 504 of the fusing agent 204 different than (e.g., less than) the second amount 406 is used to form the second region 502 with a different porosity (e.g., a greater porosity) compared to the porosity of the layer 402 of FIG. 4. For example, the porosity of the second region 502 of the example layer 500 of FIG. 5 has an 80% porosity.

The contone level control approach is also applicable during a 3D binder jetting process. For example, a contone level of the binder agent can be controlled to vary a porosity of a 3D printed mold formed via a 3D binder jetting process.

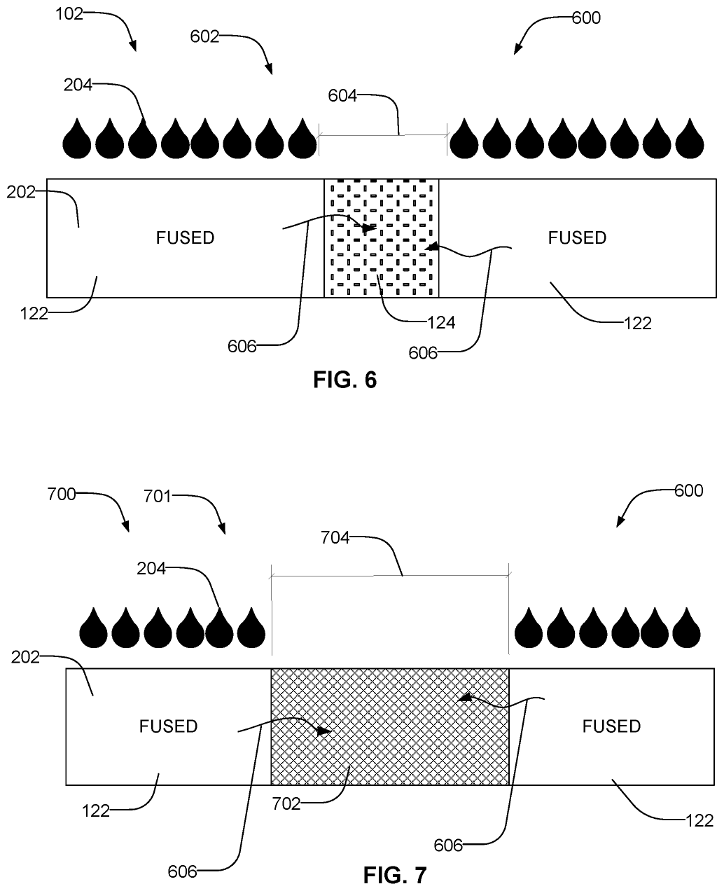

FIG. 6 is schematic illustration of an example layer 602 (e.g., the first layer 212 of FIG. 2) of the 3D printed mold 102 formed with a varying porosity between the first region 122 and the second region 124 via an example heat transfer control approach 600. To vary a porosity between the first region 122 and the second region 124 of the 3D printed mold 102, the fusing agent 204 is not provided on the second region 124. For example, the controller 104 controls the fusing agent dispenser 116 to dispense fusing agent 204 only on the build material 202 representative of the first region 122. In other words, the fusing agent 204 is not applied to a portion of the build material 202 corresponding to the second region 124.

After the fusing agent 204 is provided on the first region 122, the controller 104 causes the energy source 120 to provide energy or heat 606 to the build material 202. The heat 606 from the energy source 120 is absorbed by the fusing agent 204 on the first region 122 to cause the build material 202 to molten and, thus, solidify as a unitary structure. Additionally, heat 606 from the first region 122 transfers to the second region 124. In other words, thermal bleed from the first region 122 causes the build material 202 of the second region 124 to increase in temperature. As a result, the heat 606 transfer from the first region 122 to the second region 124 causes the build material 202 of the second region 124 to molten and solidify (e.g., after cooling). However, because the first region 122 includes the fusing agent 204, the first region 122 heats to a temperature that is greater than a temperature of the second region 124. Therefore, the build material 202 of the first region 122 becomes more molten than the build material 202 of the second region 124. To this end, a porosity of the first region 122 is less than a porosity of the second region 124. A gap size 604 of the second region 124 of the illustrated example controls an amount or level of porosity of the second region 124. For example, the gap size 604 is proportional to the porosity (e.g., the greater the gap size 604, the greater the porosity of the second region 124). For example, in the illustrated example of FIG. 6, the second region 124 has a 20% porosity.

FIG. 7 illustrates another example layer 700 of another example 3D printed mold 701 having a second region 702 that includes a porosity that is different than the porosity of the second region 124 of FIG. 6. Referring to FIG. 7, a gap size 704 of the second region 124 is greater than the gap size 604 of the second region 124 shown in FIG. 6. As a result, a porosity of the second region 124 of FIG. 7 is greater than the porosity of the second region 124 shown in FIG. 6. In other words, a degree or level of fusion and/or the degree of porosity can be varied (e.g., increased or decreased) by controlling or adjusting a gap size (e.g., the gap sizes 604, 704) of the second regions 124, 702.

The heat transfer control approach is also applicable during a SLS process. For example, a heat transfer can be controlled by varying an amount of energy (e.g., heat) provided by the energy source 120 to vary a porosity of a 3D printed mold formed via the SLS process.

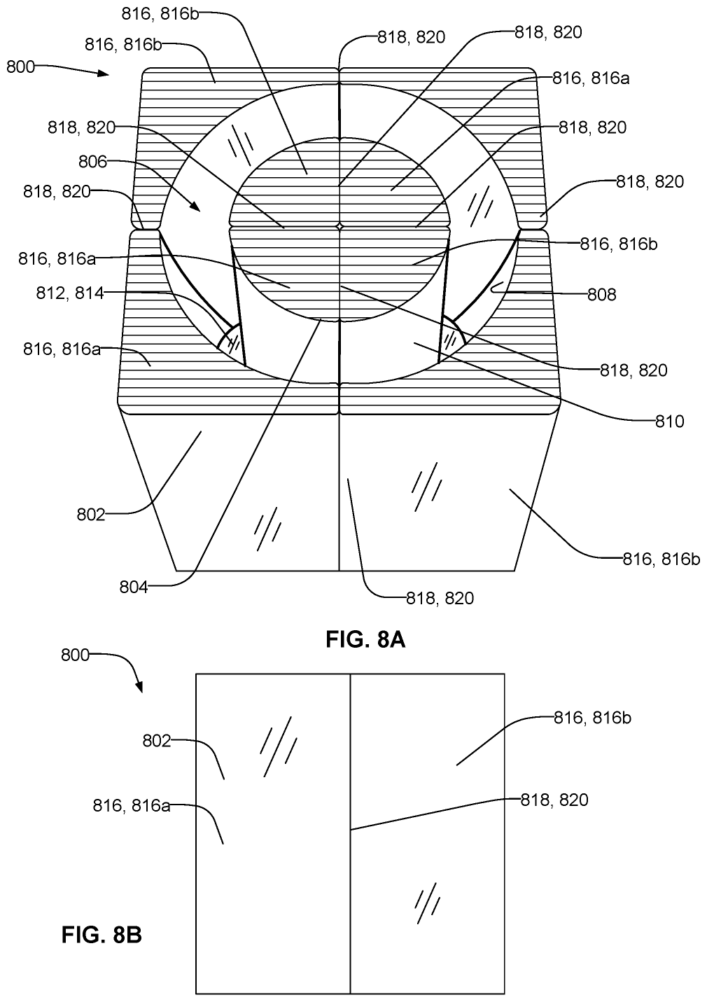

FIG. 8A is top, perspective view of an example 3D printed mold 800 that can implement the 3D printed mold 102 of FIG. 1. FIG. 8B is a partial, side view of the 3D printed mold 800 of FIG. 8A. The 3D printed mold 800 of the illustrated example is a unitary structure that is manufactured via the workstation 100 of FIG. 1. The 3D printed mold 800 includes outer wall 802, a center post 804, and a cavity 806. The cavity 806 is defined between an inner surface 808 of the outer wall 802, an outer surface 810 of the center post 804, and a base 812. The base 812 defines a bottom surface 814 of the cavity 806. The 3D printed mold 800 of the illustrated example includes a plurality of first regions 816 (e.g., the first region 122 of FIG. 1) and a plurality of second regions 818 (e.g., the second region 124 of FIG. 1). The first regions 816 have a first porosity (e.g., between 0% to 2% porosity), and the second regions 818 have a second porosity different (e.g., greater) than the first porosity. The second regions 818 of the illustrated example defines breakaway features 820.

Additionally, the second regions 818 of the illustrated example are substantially flush with the first regions 816. In other words, the second regions 818 provide a smooth transition between first portions 816a of the first regions 816 and second portions 816b of the first regions 816 positioned adjacent (e.g., separated by) the second regions 818. Although the second regions 818 have a greater porosity than the first regions 816, the second regions 818 do not define a recess, gap, channel, or other opening between the first and second portions 818a, 816b of the first regions 816. Thus, thicknesses (e.g., wall thicknesses) of the second regions 818 are substantially similar (e.g., within 1%) of thicknesses (e.g., wall thicknesses) of the first regions 816. However, in some examples, the second regions 818 can define a recess, gap, channel, or opening between the first portions 816a and the second portions 816b of the first regions 816. Additionally, the first regions 816 are composed of the same material (e.g., nylon 12) as the second regions 818 (e.g., the breakaway features 820). Additionally, the first regions 816 and the second regions 818 are formed by a plurality of layers (e.g., successive layers) defining the 3D printed mold 800. The first regions 816 of a first layer align (e.g., vertically align) with the first regions 816 of a second layer, and so on. Similarly, the second regions 818 of the first layer align (e.g., vertically align) with the second regions 818 of the second layer, and so on.

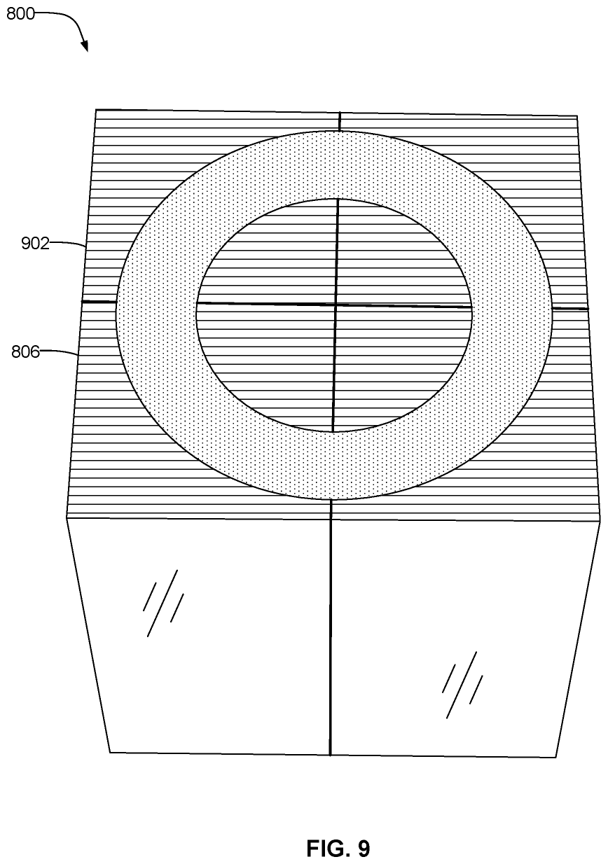

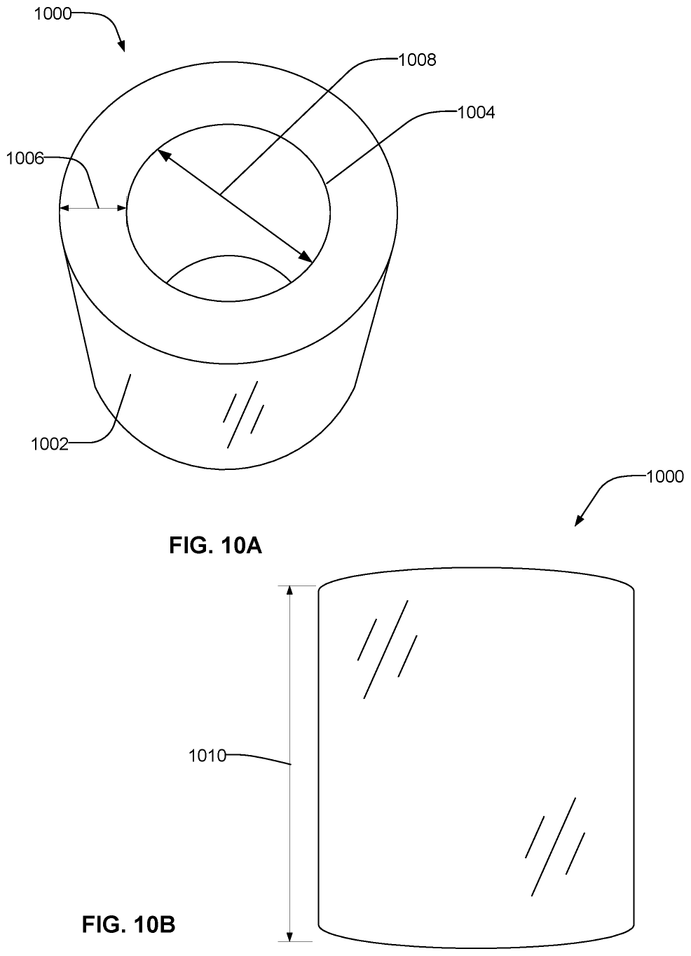

FIG. 9 is a top, perspective view of the 3D printed mold 800 of FIGS. 8A and 8B. To form a molded part, a moldable material 902 (e.g., ethylene-vinyl acetate (EVA) copolymer) is disposed or injected in the cavity 806 of the 3D printed mold 800. After the moldable material 902 solidifies, the moldable material 902 forms a molded part such as, for example, a molded part 1000 shown in FIGS. 10A and 10B.

FIGS. 10A and 10B illustrate an example molded part 1000 formed by the 3D printed mold 800 of FIGS. 8A and 8B. The 3D printed mold 800 of the illustrated example can be used to mold the molded part 1000 via other manufacturing processes (e.g., casting). The molded part 1000 of the illustrated example is a non-3D printable material. For example, the molded part 1000 is composed of a material that cannot be used to build the molded part 1000 via the workstation 100 of FIG. 1. The material of the molded part 1000 of the illustrated example is ethylene-vinyl acetate (EVA) copolymer. EVA is an elastomeric polymer that has rubber or elastomeric characteristics in stiffness and flexibility. The material has good clarity and gloss, low-temperature toughness, stress-crack resistance, hot-melt adhesive waterproof properties, and resistance to UV radiation. EVA has wide applications and commodities (e.g., shoes, foams) and biomedical engineering (e.g., drug delivery devices). Forming the molded part 1000 without use of the 3D printed mold 800 increases production timing and/or manufacturing costs. The example 3D printed mold 800 of the illustrated example enables rapid prototyping fabrication at significantly less manufacturing costs.

The molded part 1000 of the illustrated example is a cylinder. The molded part 1000 includes a cylindrical body 1002 having an opening 1004. The cylindrical body 1002 is formed by the cavity 806 of the 3D printed mold 800 and the opening 1004 is defined by the center post 804. For example, a distance between the inner surface 808 of the outer wall 802 and the outer surface 810 of the center post 804 defines a thickness 1006 of the molded part 1000 and an outer diameter of the center post 804 defines a diameter 1008 of the opening 1004. A length between the base 812 and an upper surface of the center post 804 and/or the outer wall 802 defines a length 1010 of the molded part 1000.

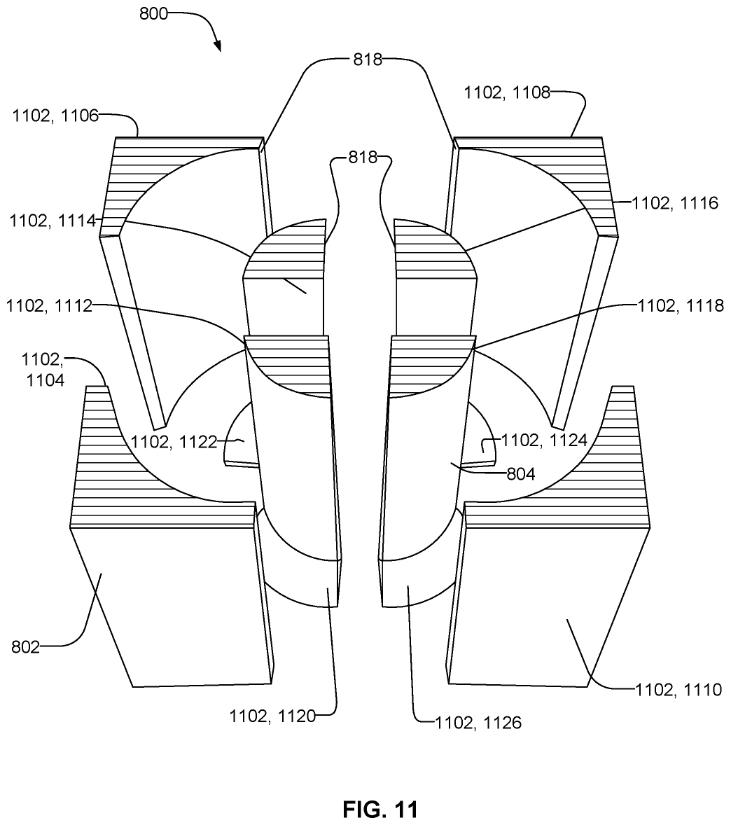

FIG. 11 illustrates the 3D printed mold 800 separated into a plurality of segments 1102 (e.g., along the second regions 818). After formation of the molded part 1000, the 3D printed mold 800 is detached from the molded part 1000. To remove the 3D printed mold 800, the 3D printed mold 800 is separated via the second regions 818. Specifically, the 3D printed mold 800 is removed or detached from the molded part 1000 by separating or breaking the 3D printed mold 800 into the segments 1102 via the breakaway features 820 defined by second regions 818. In the illustrated example, the outer wall 802 of the 3D printed mold 800 is separated into outer wall segments 1104-1110 (e.g. four segments), and the center post 804 is separated into center post segments 1112-1118 (e.g., four segments). In this example, respective ones of base segments 1120-1126 are connected with corresponding respective ones of the center post segments 1112-1118. However, in some examples, the base segments 1120-1126 may include breakaway features to separate the base segments 1120-1126 from the corresponding center post segments 1112-1118.

To separate the 3D printed mold 1000 into the plurality of segments 1102, the 3D printed mold 800 can be separated along the breakaway features 820 by an impact or force. For example, after formation of the molded part 1000, the 3D printed mold 800 can be separated into the segments 1102 by applying a fore or an impact to the second regions 818 via a tool such as, for example, a hammer and a chisel. Imparting a force to the breakaway features 820 causes the outer wall 802 and the center post 804 separate into the segments 1102. . After the 3D printed mold 800 is separated into the segments 1102, the molded part 1000 is extracted or removed (e.g., detached) from the 3D printed mold 800. Thus, the 3D printed mold 800 of the illustrated example is a one-time use mold. Though FIG. 11 shows the mold 800 separated into eight different parts, in other examples, molds can be separated into any number of different parts. Also, in some examples, the components parts of the mold can be irregular in size and shape.

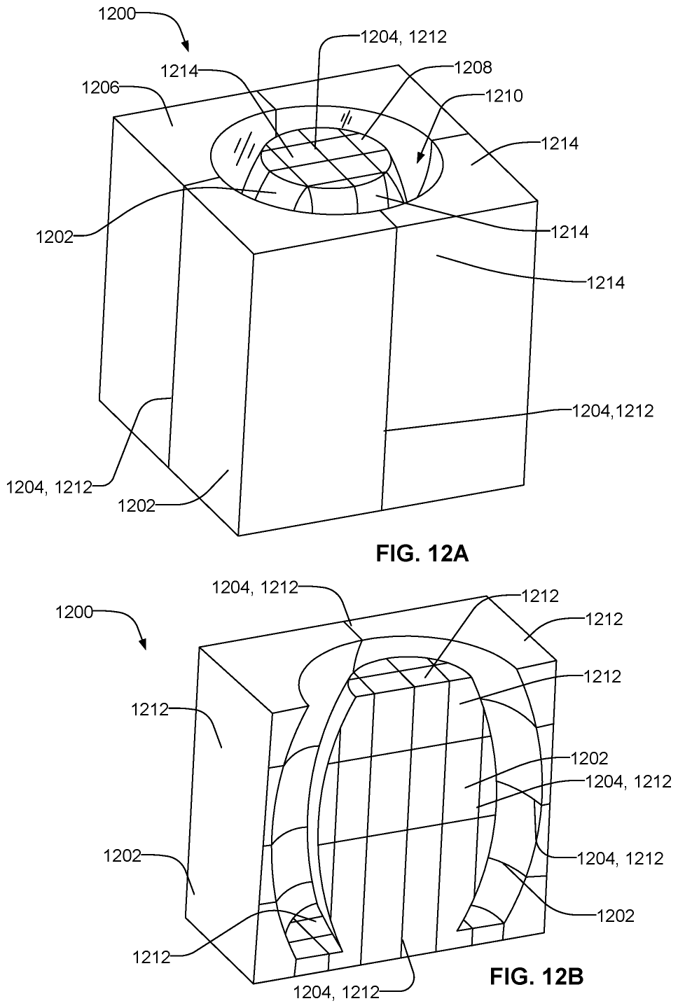

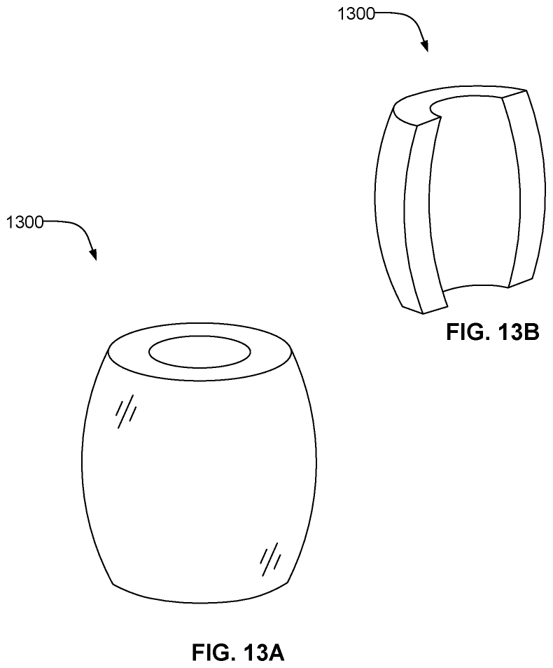

FIG. 12A is a top, perspective view of another example 3D printed mold 1200 that can implement the 3D printed mold 102 of FIG. 1. FIG. 12B is a cross-sectional view of the 3D printed mold 1200 of FIG. 12A. The 3D printed mold 1200 of the illustrated example is a unitary structure manufactured via the workstation 100 of FIG. 1. The 3D printed mold 1200 includes a plurality of first regions 1202 and a plurality of second regions 1204. The first regions 1202 of the illustrated example have a first porosity (e.g., 0% to 5% porosity) and the second regions 1204 have a second porosity (e.g., 5% to 95% porosity) different than (e.g., greater than) the first porosity. The 3D printed mold 1200 includes an outer wall 1206, a core 1208 and a cavity 1210 defined between the outer wall 1206 and the core 1208. Specifically, the second regions 1204 define a plurality of breakaway features 1212 that separate the first regions 1202 into a plurality of segments 1214 segments to remove the 3D printed mold 1200 (e.g., the core 1208) from a molded part (e.g., a molded part 1300 of FIGS. 13A and 13B).

FIG. 13A is an example molded part 1300 formed (e.g., via casting) using the 3D printed mold 1200 of FIGS. 12A and 12B. FIG. 13B is a cross-sectional view of the molded part 1300. The molded part 1300 of the illustrated example is a barrel. The molded part 1300, due to its geometry, cannot be manufactured by traditional molding or casting process because a mold core (e.g., the core 1208) in the middle of the barrel cannot be separated from the barrel after the manufacturing process. When a material is not 3D-printable, a molded part is typically machined (e.g., via CNC machine), which can be expensive and time-consuming. The 3D printed mold 1200 of the illustrated example includes a complex geometry that can be formed via 3D printable material(s) using the workstation 100 of FIG. 1 and, after formation, can be used to form the molded part 1300 using non-3D printable material(s) (e.g., plastic material(s), metallic material(s), etc.).

To implement the contone-level control approach 400 or the heat transfer control approach 600, the workstation 100 of the illustrated example determines a location to deposit or not deposit the fusing agent 204 relative to the second region 124. To detect a location of the second region 124 relative to the first region 122, the workstation 100 of the illustrated example can: (1) receive a digital image that includes identifiers corresponding to a location of the second region 124, or (2) modify a digital file with identifiers corresponding to a location of the second region 124.

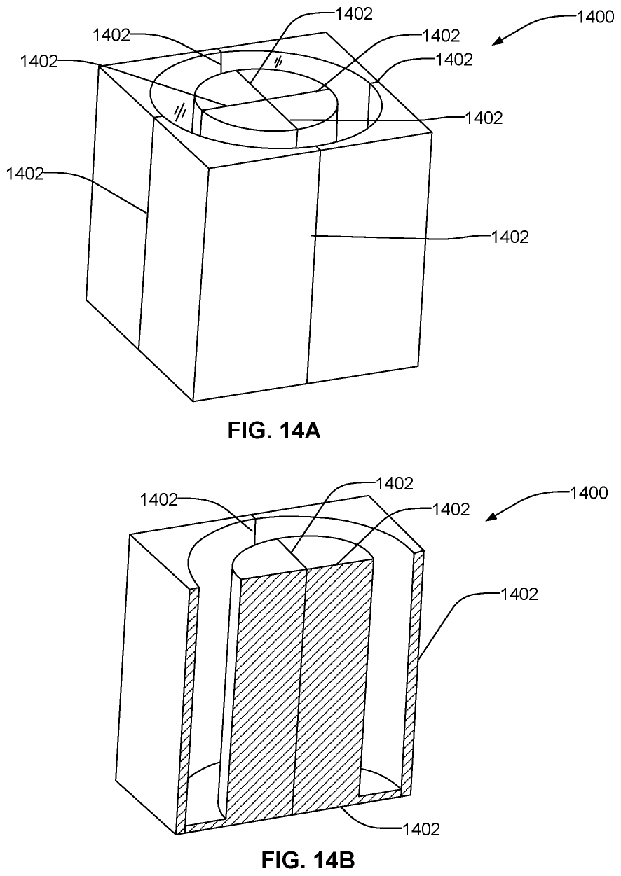

FIG. 14A illustrates a digital image or digital model 1400 representative of the 3D printed mold 800 of FIGS. 8A and 8B. FIG. 14B is a cross-sectional view of the example digital model 1400 of FIG. 14A. The digital model 1400 may be formed using a computer aided design (CAD) programming. The digital model 1400 of the illustrated example includes identifiers 1402 corresponding to a location of the second regions 818 relative to the first regions 816. The digital model 1400 of the digital model 1400 (e.g., corresponding to the 3D printed mold 800) can be a digital file (e.g., a step file) that can be sent as instructions to the workstation 100 of FIG. 1. To instruct the printer 106 where to form the breakaway features 820 (e.g., the second regions 818), the digital model 1400 of the illustrated example includes the identifiers 1402 located in the digital model 1400 of the 3D printed mold 800. For example, the identifiers 1402 include small gaps (e.g., between 1/10 of an inch to quarter inch gaps) in the digital model 1400 that represent the breakaway features 820. In some examples, the identifiers 1402 can be voids and/or any other identifiers in the digital model 1400.

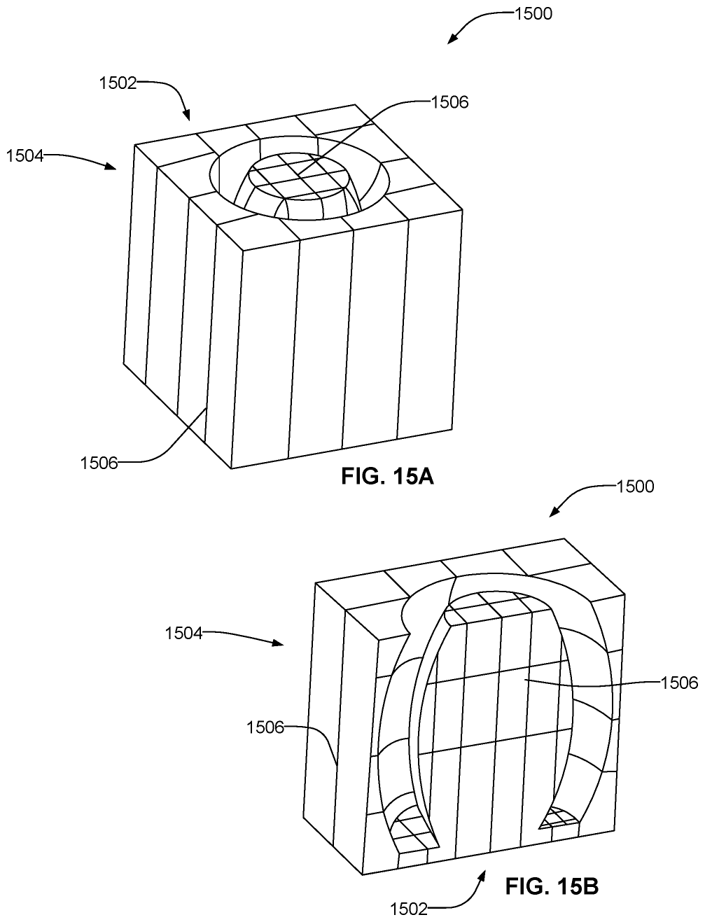

FIG. 15A is a digital image or digital model 1500 representative of the 3D printed mold 1200 of FIGS. 12A and 12B. FIG. 15B is a cross-sectional view of the example digital model 1500 of FIG. 15A. The digital model 1500 may be formed using a computer aided design (CAD) programming. The digital model 1500 of the illustrated example includes identifiers 1502 corresponding to a location of the second regions 1204 relative to the first regions 1202. However, unlike the digital model 1400 of FIGS. 14A and 14B which included the identifiers 1402, the identifiers 1502 of the illustrated example are formed or created by the controller 104 of the workstation 100 of FIG. 1. Thus, the workstation 100 of FIG. 1 receives a digital image or model representative of the 3D printed mold 1200 without the identifiers 1502. After the workstation 100 receives the digital model 1500, the controller 104, and/or more generally the workstation 100, creates the identifiers 1502 to from the digital model 1500 with the identifiers 1502. For example, to provide the identifiers 1502, the controller 104 of the illustrated example creates a mesh version or overlay on the digital model 1500 representative of the 3D printed mold 1200. Thus, in the illustrated example, after the workstation receives the digital model 1500, the workstation 100 produces the mesh overlay representative of the second regions 1204 or the breakaway features 1212 of the 3D printed mold 1200. In particular, lines 1506 of the mesh overlay correspond to the second regions 1204 of the 3D molded mold 1200. Thus, the controller 104 controls the printer 106 based on the lines 1506 of the mesh overlay 1504. For example, at the lines 1506, the controller 104 causes the fusing agent dispenser 116 to dispense the fusing agent 204 in accordance with the contone-level control approach 400 of FIG. 4 or the heat transfer control approach 600 of FIG. 6.

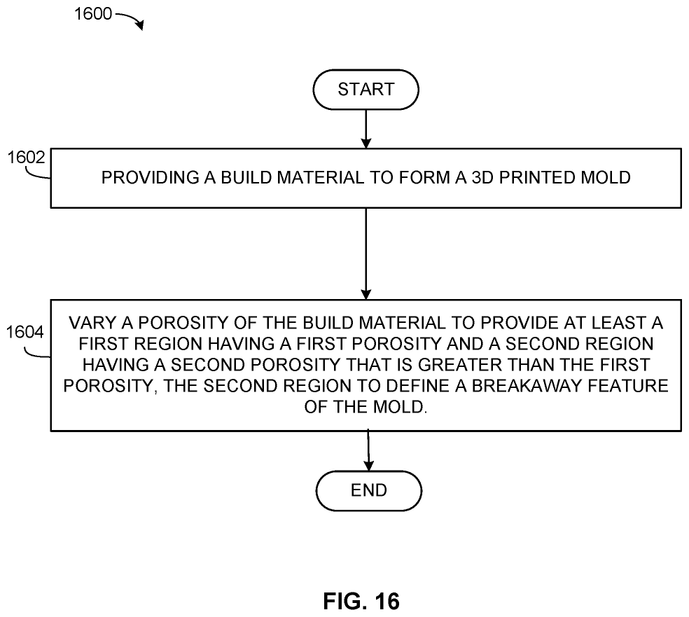

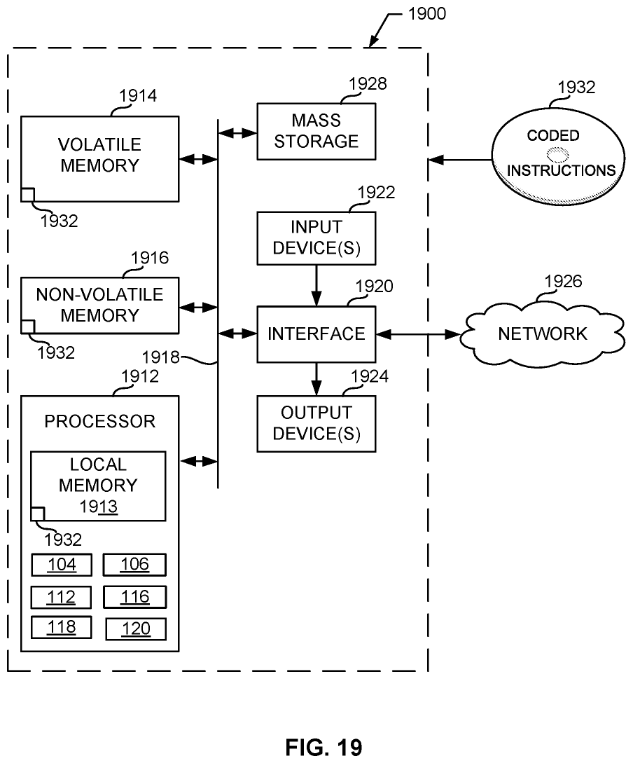

FIGS. 16-18 are example flowcharts representative of example methods 1600-1800 for manufacturing 3D printed molds (e.g., the 3D printed molds 102, 800, 1200) disclosed herein. In some examples, the blocks or processes can be re-arranged or removed, or additional blocks can be added. The example methods 1600-1800 of FIGS. 16-18 may be implemented by the example controller 104, the example printer 106, the example build material dispenser 112, the example fusing agent dispenser 116, the example detailing agent dispenser 118, the example energy source 120 and/or, more generally, the example workstation 100 of FIG. 1. In some examples, the flowcharts of FIGS. 16-18 may be representative of example hardware logic, machine readable instructions, hardware implemented state machines, and/or any combination thereof for implementing the example controller 104, the example printer 106, the example build material dispenser 112, the example fusing agent dispenser 116, the example detailing agent dispenser 118, the example energy source 120 and/or, more generally, the example workstation 100 of FIG. 1. In this example, the machine readable instructions may be an executable program or portion of an executable program for execution by a computer processor such as the processor 1912 shown in the example processor platform 1900 discussed in connection with FIG. 19. The program may be embodied in software (e.g., machine readable instructions) stored on a non-transitory computer readable storage medium such as a CD-ROM, a floppy disk, a hard drive, a DVD, a Blu-ray disk, or a memory associated with the processor 1912, but the entire program and/or parts thereof could alternatively be executed by a device other than the processor 1912 and/or embodied in firmware or dedicated hardware. Further, although the example programs are described with reference to the methods 1600-1800 illustrated in the flowcharts of FIGS. 16-18, many other methods of implementing the example controller 104, the example printer 106, the example build material dispenser 112, the example fusing agent dispenser 116, the example detailing agent dispenser 118, the example energy source 120 and/or, more generally, the example workstation 100 of FIG. 1 may alternatively be used. For example, the order of execution of the blocks may be changed, and/or some of the blocks described may be changed, eliminated, or combined. Additionally or alternatively, any or all of the blocks may be implemented by hardware circuit(s) (e.g., discrete and/or integrated analog and/or digital circuitry, an FPGA, an ASIC, a comparator, an operational-amplifier (op-amp), a logic circuit, etc.) structured to perform the corresponding operation without executing software or firmware (e.g., machine readable instructions).

As mentioned herein, the example processes of FIGS. 16-18 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C.

The example method 1600 of FIG. 16 begins by providing a build material 202 to form a 3D printed mold 102, 800, 1200 (block 1602). For example, the build material dispenser 112 dispenses the build material 202 on the support bed 114 of the workstation 100 and/or the printer 106.

After the build material 202 is dispensed on the support bed 114, breakaway features 306, 820, 1212 are formed by varying a porosity of the build material 202 to provide at least the first region 122, 816, 1202 having a first porosity and a second region 124, 818, 1204 having a second porosity that is greater than the first porosity (block 1604).

For example, to vary a porosity in connection with the contone-level control approach 400 of the MJF process, the controller 104 causes the fusing agent dispenser 116 to dispense the first amount 402 of fusing agent 204 on the build material 202 associated with the first region 122 and dispense a second amount 404 of fusing agent 204 on the build material 202 associated with the second region 124.

For example, in connection with the heat transfer control approach 600 of the MJF process, the controller 104 causes the fusing agent dispenser 116 to dispense a first amount of fusing agent 204 on the build material 202 associated with the first region 122 and does not cause the fusing agent dispenser 116 to dispense the fusing agent 204 on portions of the build material 202 associated with the second region 124.

For example, to vary a porosity in connection with a detailing agent approach, the workstation 100 of FIG. 1 can be configured to dispense a detailing agent (e.g., water) on the second region 124 to control a temperature of the second region 124 relative to the first region 122. For example, the controller 104 can cause a detailing agent dispenser to dispense a detailing agent (e.g., a liquid, water, etc.) on a build material corresponding to the second region 124. In some examples, the controller 104 causes the fusing agent dispenser 118 to dispense fusing agent 204 on the build material 202 associated with the first region 122 and the detailing agent dispenser dispenses detailing agent on the build material 202 associated with the second region 124. The detailing agent provided on the build material 202 corresponding to the second region 124 maintains a temperature of the build material 202 cooler than a temperature of the build material 202 corresponding to the first region 122 to reduce or prevent the effects of thermal bleed from the heat of the first region 122 to the second region 124 due to the temperature of the first region 122, which causes a porosity variance between the first and second regions 122, 124.

For example, to vary a porosity of a 3D printed mold 102 in connection with a SLS process, the controller 104 can command the energy source 120 to vary an amount of energy provided to the build material. For example, the controller 104 commands the energy source 104 to provide a first amount of energy to the first region of the 3D printed mold and a second amount of energy different than the first to a second region of the 3D printed mold.

For example, to vary a porosity of a 3D printed mold 102 in connection with a 3D binder jetting process, the controller 104 can vary at least one of a binder agent provided to a build material or an amount of energy provided to the binder agent and the build material. For example, to vary the porosity between first and second regions, the controller 104 can cause the binder agent dispenser to dispense a first amount of binder agent on a first region (e.g., of a first layer) of the 3D printed mold and a second amount of binder agent on a second region (e.g., of the first layer) of the 3D printed mold. In some examples, to vary the porosity, the controller 104 causes the energy source 120 to provide a first amount of energy or first energy level to a first region (e.g., of a first layer) of the 3D printed mold and a second amount of energy or second energy level to a second region (e.g., a second layer) of the 3D printed mold. In some examples, a porosity between a first region and a second region of the 3D printed mold can be varied by varying the binder agent and the energy applied to the binder agent and a build material.

In some examples, the workstation 100 receives the digital model 1400 representative of the 3D printed mold 102 that includes the identifiers 1402 associated with the second regions 818 and/or modifies or creates the digital model 1500 with the identifiers 1502 associated with the second regions 1204. The controller 104 determines a pattern representative of the first regions 816, 1202 based on the digital model 1400, 1500 and the second regions 818, 1204 based on the identifiers 1402, 1502, respectively.

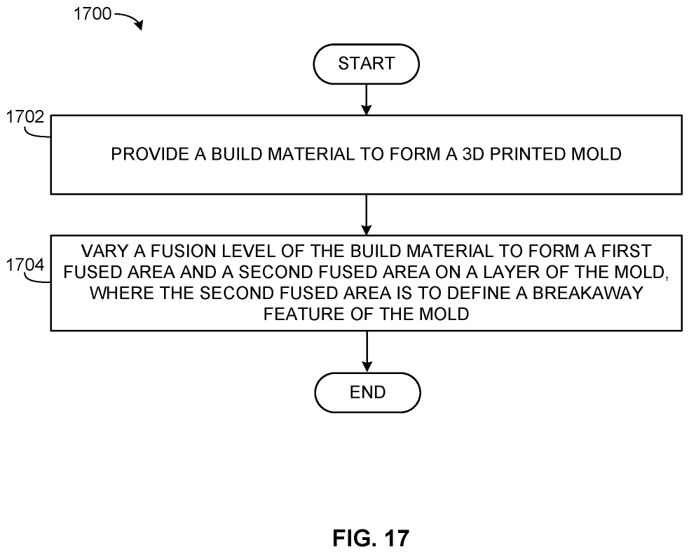

Referring to FIG. 17, the example method 1700 includes providing a build material 202 to form a 3D printed mold 102, 800, 1200 (block 1702). For example, the build material dispenser 112 dispenses the build material 202 on the support bed 114 of the workstation 100 and/or the printer 106. After the build material 202 is dispensed on the support bed 114, a breakaway feature 306, 820, 1212 is formed by varying a fusion level of the build material 202 to form a first fused area (e.g., the first region 122, 816, 1202) and a second fused area (e.g., the second region 124, 818, 1204) on layer(s) of the 3D printed mold 102, 800, 1200 (block 1704).

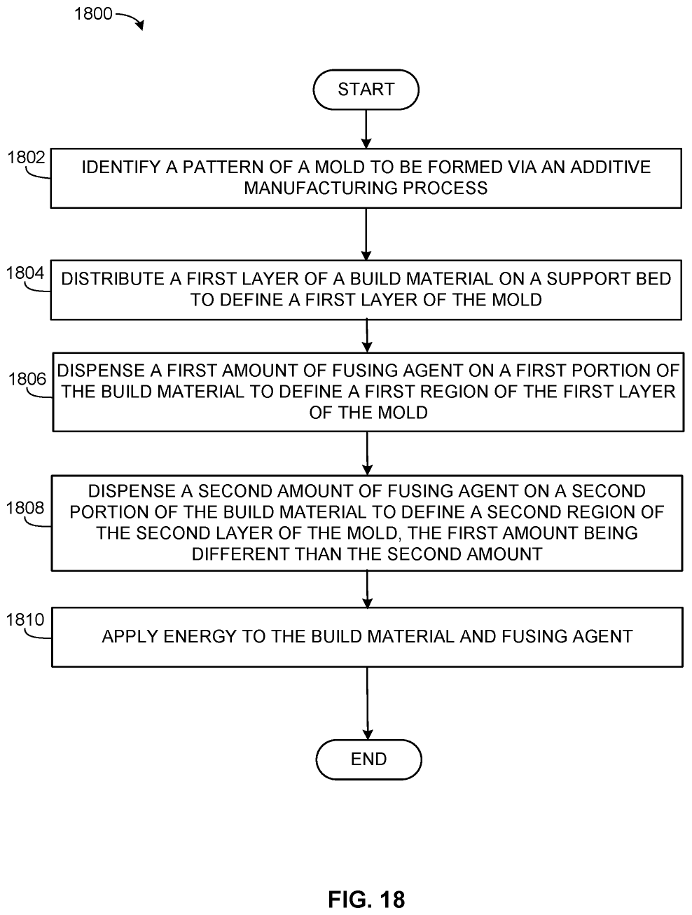

Referring to FIG. 18, the method 1800 includes identifying a pattern of a mold (e.g., the 3D printed molds 102, 800, 1200) to be formed via an additive manufacturing process 200 (block 1802). In some examples, the workstation 100 receives the digital model 1400 of the 3D printed mold 102 that includes the identifiers 1402 associated with the second regions 818 and/or modifies the digital model 1500 to create the identifiers 1502 associated with the second regions 1204. The controller 104 determines a pattern representative of the first regions 816, 1202 based on the digital model 1400, 1500 and the second regions 818, 1204 based on the identifiers 1402, 1502, respectively.

The controller 104 of the illustrated example causes the build material dispenser 112 to distribute a first layer of the build material 202 on the support bed 114 to define the first layer 212, 402, 500, 602, 700 of the 3D printed mold 102, 800, 1200 (block 1804).

The controller 104 of the illustrated example causes the fusing agent dispenser 116 to dispense a first amount 402 of the fusing agent 204 on a first portion of the build material 202 to define the first region 122, 816, 1202 of the first layer 212, 402, 500, 602, 700 of the 3D printed mold 102, 800, 1200 (block 1806). The controller 104 also causes the fusing agent dispenser 116 to dispense a second amount 404 of the fusing agent 204 on a second portion of the first layer of the build material 202 to define a second region 124, 818, 1204 of the first layer 212, 402, 500, 602, 700 of the 3D printed mold 102, 800, 1200, where the first amount 402 is different than (e.g., greater than) the second amount 404 (block 1808). For example, the controller 104 operates the build material dispenser 112 and/or the fusing agent dispenser 116 based on the identifiers 1402, 1502 and the pattern provided by the digital model 1400, 1500.

To solidify the first layer 212, 402, 500, 602, 700 of the 3D printed mold 102, 800, 1200, the controller 104 causes the energy source 120 to apply energy (e.g., heat) to the first layer of the build material 202 and the fusing agent 204 (block 1810). The energy provided by the energy source 120 is to cause the build material 202 to molten and solidify into the first layer 212, 402, 500, 602, 700 of the 3D printed mold 102, 800, 1200 after cooling. The process is repeated until all layers defining the 3D printed mold 102, 800, 1200 are complete.

FIG. 19 is a block diagram of an example processor platform 1900 structured to execute the instructions of the example processes of FIGS. 16-18 to implement the example controller 104, the example printer 106, the example build material dispenser 112, the example fusing agent dispenser 116, the detailing agent dispenser 118, the example energy source 120 and/or, more generally, the example workstation 100 of FIG. 1. The processor platform 1900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 1900 of the illustrated example includes a processor 1912. The processor 1912 of the illustrated example is hardware. For example, the processor 1912 can be implemented by integrated circuit(s), logic circuit(s), microprocessor(s), GPU(s), DSP(s), or controller(s) from any desired family or manufacturer. The hardware processor may be a semiconductor based (e.g., silicon based) device. In this example, the processor implements aspect(s) of the example controller 104, the example printer 106, the example build material dispenser 112, the example fusing agent dispenser 116, the detailing agent dispenser 118, the example energy source 120 and/or, more generally, the example workstation 100 of FIG. 1.

The processor 1912 of the illustrated example includes a local memory 1913 (e.g., a cache). The processor 1912 of the illustrated example is in communication with a main memory including a volatile memory 1414 and a non-volatile memory 1916 via a bus 1918. The volatile memory 1914 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1416 may be implemented by flash memory and/or any other desired type of memory device. Access to the main memory 1914, 1916 is controlled by a memory controller.

The processor platform 1900 of the illustrated example also includes an interface circuit 1920. The interface circuit 1920 may be implemented by any type of interface standard, such as an Ethernet interface, a universal serial bus (USB), a Bluetooth® interface, a near field communication (NFC) interface, and/or a PCI express interface.

In the illustrated example, input device(s) 1922 are connected to the interface circuit 1920. The input device(s) 1922 permit(s) a user to enter data and/or commands into the processor 1912. The input device(s) can be implemented by, for example, an audio sensor, a microphone, a camera (still or video), a keyboard, a button, a mouse, a touchscreen, a track-pad, a trackball, isopoint, and/or a voice recognition system.

Output device(s) 1924 are also connected to the interface circuit 1920 of the illustrated example. The output devices 1924 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer, and/or speaker. The interface circuit 1920 of the illustrated example, thus, typically includes a graphics driver card, a graphics driver chip and/or a graphics driver processor.

The interface circuit 1920 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1926. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1900 of the illustrated example also includes mass storage device(s) 1928 for storing software (e.g., machine readable instructions) and/or data. Examples of such mass storage devices 1928 include floppy disk drives, hard drive disks, compact disk drives, Blu-ray disk drives, redundant array of independent disks (RAID) systems, and digital versatile disk (DVD) drives.

The machine executable instructions 1932 of FIGS. 16-18 may be stored in the mass storage device 1928, in the volatile memory 1914, in the non-volatile memory 1916, and/or on a removable non-transitory computer readable storage medium such as a CD or DVD.

The example methods, apparatus, systems, and articles of manufacture disclosed herein provide breakaway features for easy mold breakdown and removal. The breakaway features are formed by portions of the mold that are relatively weakly connected or coupled to stronger portions of the mold. A strength (e.g., or weakness) of the breakaway features can be varied during printing of the 3D printed mold. As a result, the mold has strength to withstand handling and maintain its shape during a molding process. Meanwhile, the mold can be broken down easily after a molded part is formed using the mold. The example 3D printed molds disclosed herein can be formed with higher geometric accuracy or precision than forming a mold using other manufacturing processes (e.g., machining).

At least some of the aforementioned examples include at least one feature and/or benefit including, but not limited to, the following:

In some examples, a method for forming a mold having a cavity by creating a plurality of layers using an additive manufacturing process includes: providing a build material; and varying a fusion level applied to the build material to form a first fused area and a second fused area on a layer of of the mold, the second fused area is to define a breakaway feature of the mold.

In some examples, the method includes varying of the fusion level by controlling a contone level of at least one of a fusing agent or a detailing agent.

In some examples, the method includes varying of the fusion level by controlling a heat transfer.

In some examples, the method includes varying the fusion level to cause a variation in porosity between the first fused area and the second fused area.

In some examples, the second fused area has a mechanical strength that is lower than a mechanical strength of the first fused area.

In some examples, the method includes forming the first fused area and the second fused area on the plurality of layers.

In some examples, the method includes after formation of the mold, further including: providing a moldable material in the cavity of the mold to form a molded part; and removing the mold from the mold part by breaking the mold from the molded part via the breakaway feature defined by the second fused area.

In some examples, a method for forming a mold having a cavity by creating a plurality of layers using an additive manufacturing process includes: providing a build material to form the mold; and varying a porosity of the build material to provide at least a first region having a first porosity and a second region having a second porosity that is greater than the first porosity, where the second region to define a breakaway feature of the mold.

In some examples, the method includes varying the porosity of the mold includes dispensing a first amount of fusing agent on the build material that is to define the first region and dispensing a second amount of fusing agent on the build material that is to define the second region.

In some examples, a thickness of the first region is substantially equal to a thickness of the second region.

In some examples, a method includes: identifying a pattern of a mold to be formed via an additive manufacturing process; distributing a first layer of a build material on a support bed to define a first layer of the mold; dispensing a first amount of fusing agent on a first portion of the build material to define a first region of the first layer of the mold; dispensing a second amount of fusing agent on a second portion of the build material to define a second region of the first layer the mold, the first amount being different than the second amount; and applying energy, via an energy source, to the fusing agent to fuse the build material and solidify the first layer of the mold.

In some examples, the method further includes: distributing the build material on the first layer of the mold to define a second layer of the mold; dispensing a third amount of the fusing agent on a third portion of the build material to define a third region of the second layer of the mold; dispensing a fourth amount of the fusing agent on a fourth portion of the build material to define a fourth region of the second layer of the mold, the first amount being different than the second amount; and applying energy, via an energy source, to the fusing agent to fuse the build material and solidify the second layer of the mold.

In some examples, the method includes aligning the third region of the second layer with the first region of the first layer, and aligning the fourth region of the second layer with the second region of the first layer

In some examples, a system includes a build material dispenser to produce a 3D printed mold by dispensing a build material on a support bed via an additive manufacturing process. A fusing agent dispenser is to dispense a first amount of fusing agent on the build material corresponding to a first region of the 3D printed mold and a second amount of fusing agent on the build material corresponding to a second region of the 3D printed mold, where the first amount being greater than the second amount.

In some examples, the system includes an energy source to apply heat to the build material and the fusing agent, the first amount of fusing agent to cause the first region to have a first porosity and the second amount of fusing agent to cause the second region to have a second porosity greater than the first porosity.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A method for forming a mold having a cavity by creating a plurality of layers using an additive manufacturing process, the method comprising:
providing a build material; and
varying a fusion level applied to the build material to form a first fused area and a second fused area on a layer of the mold, the second fused area is to define a breakaway feature of the mold.

2. The method of claim 1, wherein the varying of the fusion level includes controlling a contone level of at least one of a fusing agent or a detailing agent.

3. The method of claim 1, wherein the varying of the fusion level includes controlling a heat transfer.

4. The method of claim 1, wherein the varying of the fusion level includes varying at least one of a binder agent or an energy level provided to the first fused area and the second fused area.

5. The method of claim 1, wherein the varying of the fusion level includes varying an energy level provided to the first fused area and the second fused area.

6. The method of claim 1, wherein the varying of the fusion level includes providing a detailing agent to the build material associated with the second fused area.

7. The method of claim 1, wherein varying the fusion level is to cause a variation in porosity between the first fused area and the second fused area.

8. The method of claim 1, wherein the second fused area has a mechanical strength that is lower than a mechanical strength of the first fused area.

9. The method of claim 1, further including forming the first fused area and the second fused area on the plurality of layers.

10. The method of claim 1, wherein after formation of the mold, further including:
providing a moldable material in the cavity of the mold to form a molded part; and
removing the mold from the mold part by breaking the mold from the molded part via the breakaway feature defined by the second fused area.

11. A method for forming a mold having a cavity by creating a plurality of layers using an additive manufacturing process, the method comprising:
providing a build material to form the mold; and
varying a porosity of the build material to provide at least a first region having a first porosity and a second region having a second porosity that is greater than the first porosity, the second region to define a breakaway feature of the mold.

12. The method of claim 11, wherein varying the porosity of the mold includes dispensing a first amount of fusing agent on the build material that is to define the first region and dispensing a second amount of fusing agent on the build material that is to define the second region.

13. The method of claim 11, wherein varying the porosity includes varying at least one of an amount of a binder agent or an energy level provided to the build material during a 3D printing process.

14. A method comprising:
identifying a pattern of a mold to be formed via an additive manufacturing process;
distributing a first layer of a build material on a support bed to define a first layer of the mold;
dispensing a first amount of fusing agent on a first portion of the build material to define a first region of the first layer of the mold;
dispensing a second amount of fusing agent on a second portion of the build material to define a second region of the first layer the mold, the first amount being different than the second amount; and
applying energy, via an energy source, to the fusing agent to fuse the build material and solidify the first layer of the mold.

15. The method of claim 14, further including:
distributing the build material on the first layer of the mold to define a second layer of the mold;
dispensing a third amount of the fusing agent on a third portion of the build material to define a third region of the second layer of the mold;
dispensing a fourth amount of the fusing agent on a fourth portion of the build material to define a fourth region of the second layer of the mold, the first amount being different than the second amount; and
applying energy, via an energy source, to the fusing agent to fuse the build material and solidify the second layer of the mold.

16. The method of claim 15, further including aligning the third region of the second layer with the first region of the first layer, and aligning the fourth region of the second layer with the second region of the first layer.
